(19) United States
(12) Patent Application Publication
(10) Pub. No.: US 2016/0122165 A1
(43) Pub. Date: May 5, 2016

(54) TROLLEY JACK COMPRISING A HINGED LEVER ASSEMBLY

(71) Applicant: MELCHOR GABILONDO, S.A., Berriz (Vizcaya) (ES)

(72) Inventor: Antonio Martinez Martinez, Berriz (Vizcaya) (ES)

(21) Appl. No.: 14/892,571

(22) PCT Filed: Apr. 23, 2014
(86) PCT No.: PCT/ES2014/070355

§ 371 Date: Nov. 19, 2015

(30) Foreign Application Priority Data
May 20, 2013 (ES) P 201300469

(51) Int. Cl. B66F 5/04

(52) U.S. Cl. CPC B66F 5/04

(57) ABSTRACT

The present invention relates to a trolley jack comprising a main body and a lifting element capable of moving up or down for lifting a heavy object, and a lever assembly projecting upwards along a longitudinal axis for allowing a user to manually push and move the jack, where a lower end of the lever assembly is connected in an articulated manner to the main body according to a transverse axis of rotation, the lever assembly being capable of being lowered with respect to said transverse axis of rotation and arranged against the main body. Providing a hinged lever assembly increases jack storage and transport possibilities.

### FIELD OF THE ART

The invention relates to a trolley jack of the type that aids in lifting vehicles or other heavy objects.

### STATE OF THE ART

Trolley jacks are apparatus widely used in workshops or other places where mechanical work are performed for lifting heavy objects such as vehicles. A trolley jack generally comprises a main body with respect to which there is movably arranged a type of lifting element which, when duly actuated by means of a hydraulic system or the like, is capable of being lifted, exerting enough force under the vehicle or heavy object to lift it. Some examples of lifting elements are a liftable articulated arm, a telescopic mechanism capable of extending vertically upwards or in an oblique direction with an upward vertical component, etc. Additionally, the trolley jack comprises operating means so that the user can cause actuation of the hydraulic system or the like and subsequent upward movement of the lifting element. The jack also comprises operating means to allow controlled lowering of the lifting element. Lowering must be done in a controlled manner since the lifting element is generally lowered bearing a load thereon, i.e., while it supports the weight of the vehicle or other heavy object, and preventing the object from losing balance, overturning or falling is therefore vital to assure operator and load safety.

Known trolley jacks are capable of being moved around by means of wheels, rollers or other rolling elements comprised in the main body. Given that the main body is generally located very close to the ground and has a relatively low height, jacks usually comprise a lever assembly projecting upwards from the main body to provide the user with a gripping area which the user pulls or pushes to move the jack from one side to another, or for rotating the carriage.

Generally, the lever assembly itself also allows the user to actuate or activate the upward and downward movement of the lifting element with respect to the main body for lifting and lowering the load, respectively. Therefore, the user must often push the lever assembly in a downwardly rotating direction repeatedly (as if repeating the movement of a lever) in order to act on the operating means, in turn lifting the lifting element and the load supported thereon. In contrast, for lowering the load, the user must often rotate the lever assembly a specific angle about itself, i.e., about a central longitudinal axis thereof; said rotation activates the operating means which allow unloading or lowering of the lifting element and of the load supported thereon.

The objective of the present invention is to provide an improvement over hydraulic jacks with a conventional lever assembly. Said improvement will consist of providing the lever assembly with an additional functionality, maintaining an extremely intuitive use thereof such that a user accustomed to using a conventional lever assembly is automatically and completely capable of successfully and safely using the lever assembly according to the invention. As regards safety, another objective of the invention, which at the same time adds an additional functionality to the lever assembly, is to assure that the likelihood or risk of the user accidentally activating unloading or lowering of the lifting element is not increased.

### BRIEF DESCRIPTION OF THE INVENTION

The object of the invention is a trolley jack comprising a main body with respect to which a lifting element is capable of moving up or down for lifting a heavy object, and a lever assembly capable of projecting upwards from the main body along a longitudinal axis for allowing a user to manually push and move the carriage. Furthermore, the jack according to the invention has the particularity that a lower end of the lever assembly is connected in an articulated manner to the main body, said connection being articulated with respect to a transverse axis of rotation. The lever assembly is capable of being lowered with respect to said transverse axis of rotation and arranged against the main body.

The trolley jack according to the invention therefore has a lever assembly with an added functionality, i.e., being able to be folded against the main body. This greatly facilitates jack storage when it is not being used, given that the user can fold the lever assembly against the main body as a prior step before storing the jack, whereby the jack occupies much less space than in the situation of use (i.e., when the lever assembly projects upwards according to a longitudinal axis for allowing a user to handle and move the jack). Therefore by means of the invention, the jack can be stored in places where it could not be stored up until now, for example, in an empty space of reduced height below a machine, cupboard, table or the like.

The jack according to the invention optionally comprises at least one securing element for fixing the position of the lever assembly when it is lowered with respect to the transverse axis of rotation and arranged against the main body. This allows improving storage since the lever assembly is prevented from detaching from the main body in an undesirable manner. Furthermore, being able to secure the lever assembly against the main body offers new jack transport possibilities in cases in which the trolley jack has a reduced weight: once the lever assembly is secured against the main body, the user can grip the lever assembly, lift the jack off the ground and transport the jack with their hands, holding it by the lever assembly. Other optional or preferred embodiments of the invention offer additional advantages which will be described below in the detailed description of the invention.

### BRIEF DESCRIPTION OF THE DRAWINGS

The details of the invention are shown in the attached drawings which do not seek to limit the scope of the invention:

FIG. 1 shows a perspective view of a first embodiment of the trolley jack according to the invention.

FIG. 2 shows the jack of the preceding figure in a first situation in which the lever assembly is in a position of use.

FIG. 3 shows the jack of the preceding figure in a second situation in which the lever assembly is folded against the main body.

FIG. 4 shows a user carrying the jack in the situation of FIG. 3.

FIG. 5 shows a perspective view of a second embodiment of the trolley jack according to the invention, the jack being in a first situation in which the lever assembly is in a position of use.

FIG. 6 shows the jack of the preceding figure in a second situation in which the lever assembly is folded against the main body.

FIG. 7 shows a partial rear perspective view of the jack of FIG. 5.

FIG. 8 shows a partial side view of the jack of FIG. 5.

FIG. 9 shows a user dragging the jack of FIG. 5.

FIG. 10 shows a perspective view of a third embodiment of the trolley jack according to the invention.

FIGS. 11A, 11B and 11C show a first operating sequence of the lever assembly of the jack of FIG. 10, in which the lever assembly is rotated with respect to the longitudinal axis.

FIGS. 12A, 12B and 12C show a second operating sequence of the lever assembly of the jack of FIG. 10, in which the lever assembly is rotated with respect to the transverse axis of rotation.

FIGS. 13A, 13B and 13C show three respective side views in partial cross-section of the assemblies of FIGS. 12A, 12B and 12C, the three sections being according to section plane A-A illustrated in FIG. 12A.

### DETAILED DESCRIPTION OF THE INVENTION

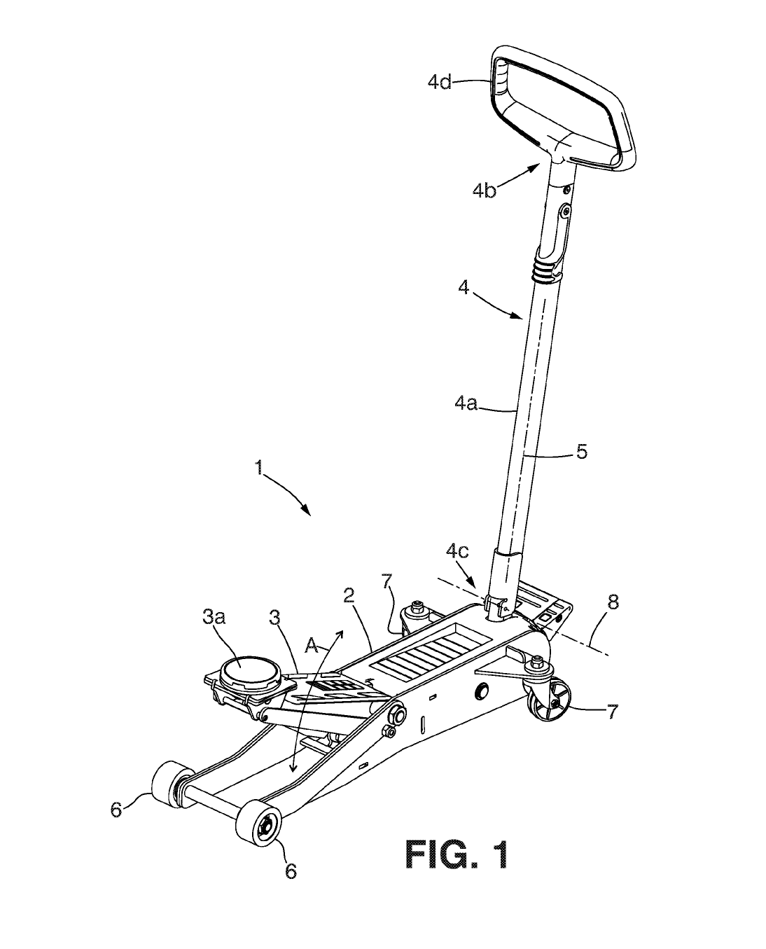

FIG. 1 shows a perspective view of an embodiment of the trolley jack according to the invention. The jack (1) comprises a main body (2) with respect to which a lifting element (3) is capable of moving up or down as indicated by the arrow (A). The upward or downward movement of the lifting element (3) lifts or lowers a ramming end (3a) of the lifting element (3) intended for applying lifting force on a heavy object, for example a vehicle, and lifting said object. The jack (1) further comprises a lever assembly (4) which in the situation of use, as depicted in this drawing, projects upwards from the main body (2) along a longitudinal axis (5). The lifting element (3) in the depicted embodiment is a liftable arm articulated to the main body (2) and operated by a hydraulically operated system not seen in the drawing. The lever assembly (4) comprises an elongated portion (4a), an upper end (4b) and a lower end (4c). The lower end (4c) of the lever assembly (4) is connected to the main body (2). The lever assembly (4) further comprises a handle (4d) at its upper end (4b), where said handle (4d) allows a user to grip the lever assembly (4), push it and cause subsequent movement of the jack (1). To allow moving the jack around, wheels or rolling elements are generally connected to the main body (2) in its lower area, specifically front rolling elements (6) and rear rolling elements (7), as shown in the embodiment in the drawing.

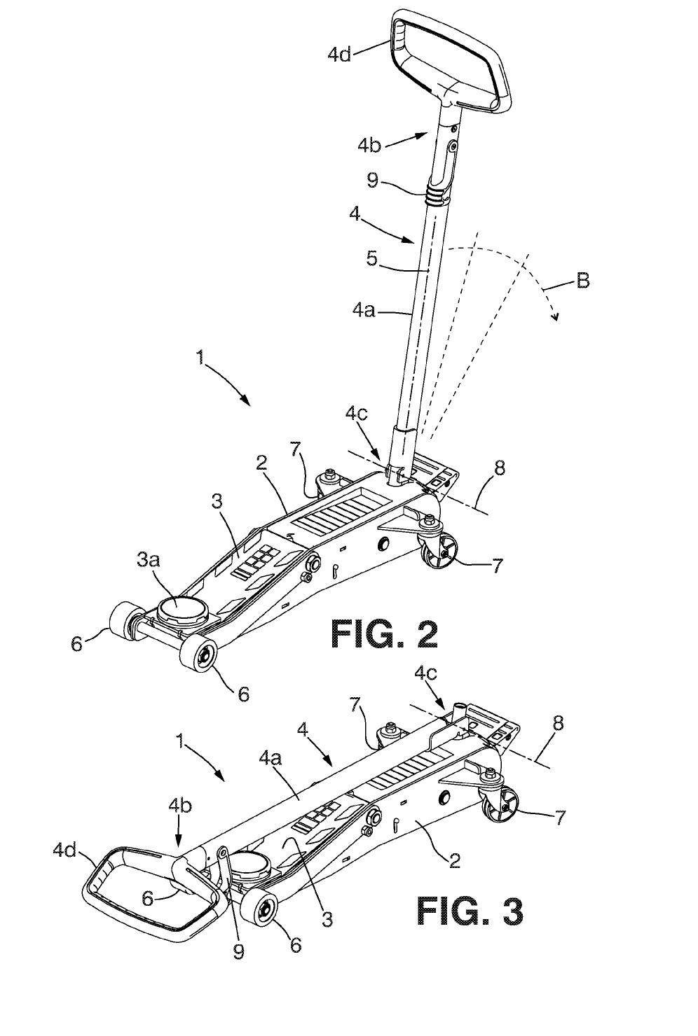

FIG. 2 shows the embodiment of the preceding drawing in a situation in which the lifting element (3) is in its lowest position and in which the lever assembly (4) projects upwards from the main body (2) along the longitudinal axis (5) for allowing a user to manually push and move the jack (1) around. In this situation, the jack (1) is ready to be used for lifting an object. Said lifting is performed, for example, by operating the lever assembly (4), pulling back on it using repetitive lever-type movements schematically indicated with the arrow (B).

According to the invention, the lower end (4c) of the lever assembly (4) is connected to the main body (2) in an articulated manner with respect to a transverse axis of rotation (8) located in the rear area of the main body (2). The lever assembly (4) is capable of being lowered with respect to said transverse axis of rotation (8) and arranged against the main body (2), as shown in FIG. 3. Said lowering allows reducing the total space occupied by the jack (1) with respect to the situation of use of FIG. 2, such that the jack (1) with the lever assembly (4) folded as shown in FIG. 3 is more compact and easier to store.

The jack (1) preferably comprises at least one securing element (9) for fixing the position of the lever assembly (4) when it is lowered with respect to the transverse axis of rotation (8) and arranged against the main body (2). In the depicted embodiment, the securing element (9) is in the form of a dog or hook connected in an articulated manner to the upper end (4b) of the lever assembly (4) and coupled to the axle of the front wheels or rolling elements (6), as shown in FIG. 3. Nevertheless, alternative embodiments in which the securing element (9) is any other element that allows fixing the position of the lever assembly (4) once it is lowered against the main body (2) are contemplated so that said lever assembly (4) does not detach from the main body (4) by accident and it only detaches therefrom if the user pulls the lever assembly (4) in the decoupling direction with a force greater than a threshold or if the securing element (9) becomes disconnected or decoupled.

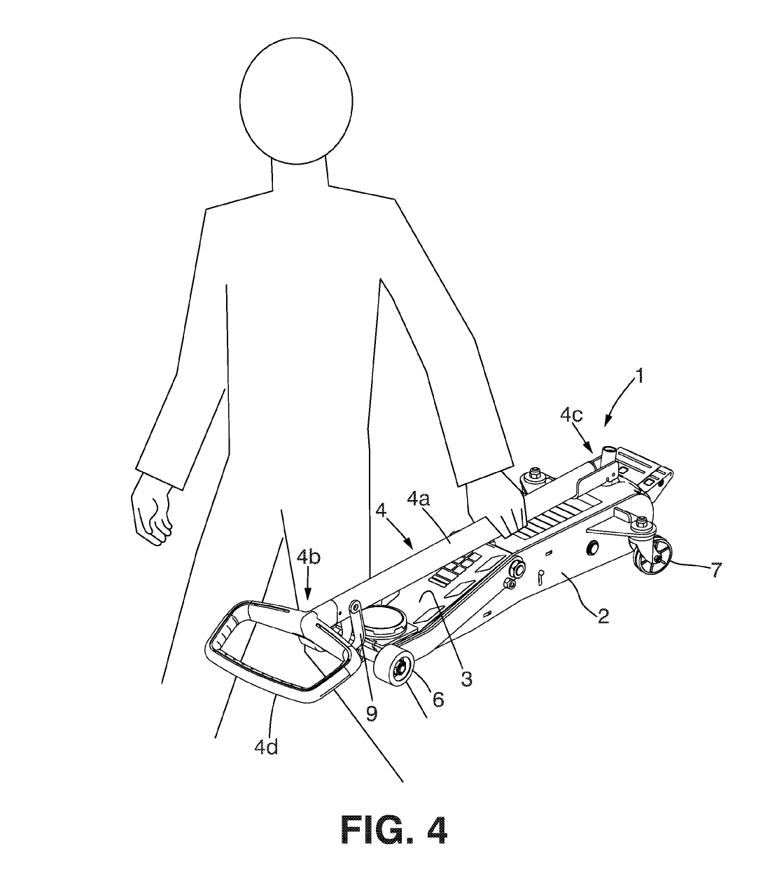

The presence of a securing element (9) capable of fixing the position of the lever assembly (4) when it is lowered with respect to the transverse axis of rotation (8) and arranged against the main body (2) allows attaining very interesting advantages for usage. Primarily, undesirable decoupling of the lever assembly (4) is prevented, which facilitates handling the jack (1) and increases user safety. If the jack (1) has a sufficiently low weight, it further allows the user to grip the jack (1) by the elongated portion (4a) of the folded lever assembly (4), lift the jack (1) off the ground and transport it with their hands by comfortably holding it by the lever assembly (4), as shown in FIG. 4. This way of transporting the jack is very efficient and agile for jacks having a reduced weight, compared to pushing the jack (1) and rolling it over the ground.

Optionally, the lever assembly (4), particularly the elongated portion (4a), is telescopic and its length is variable. This allows adjusting the length of the lever assembly (4) to the length of the jack (1) such that when the lever assembly (4) is lowered against the main body (2), the handle (4d) and potentially the elongated portion (4a) of the lever assembly (4) do not project excessively and unnecessarily from the main body (2). This thereby favors making the jack (1) more compact before storage in a manner that is always comfortable and easy for the user to do.

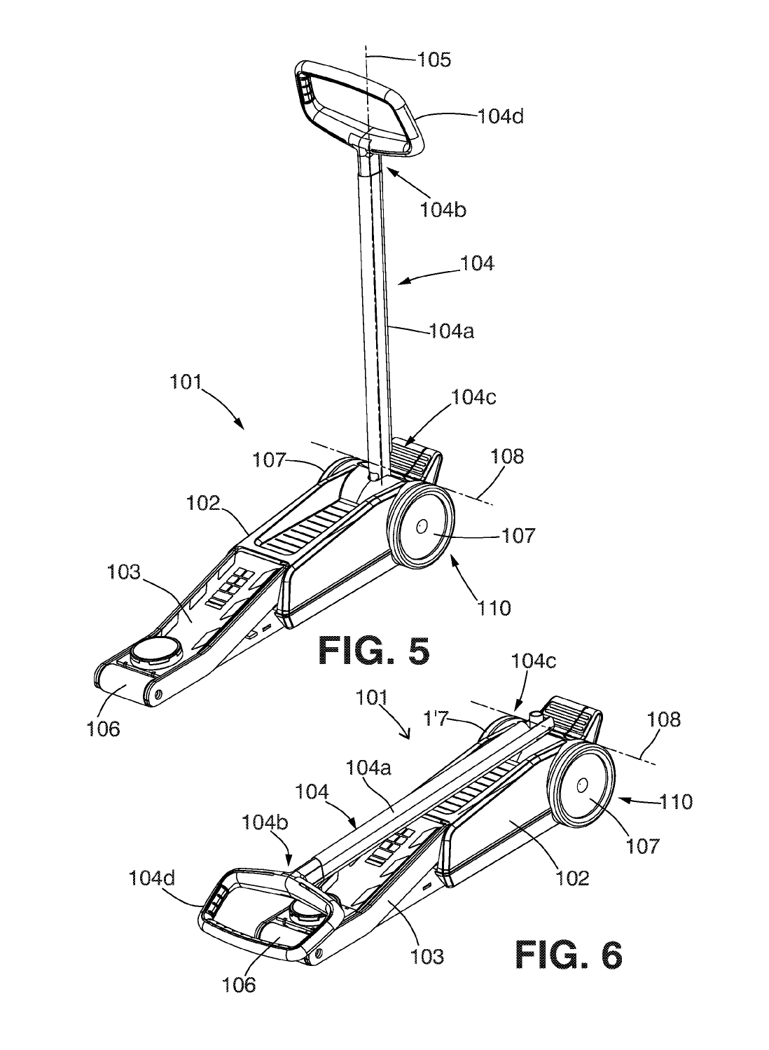

FIGS. 5 and 6 show two perspective views of a second embodiment of a jack (101) according to the invention comprising a main body (102) with respect to which a lifting element (103) is capable of moving up or down for lifting a heavy object, and a lever assembly (104) capable of projecting upwards from the main body (102) along a longitudinal axis (105) for allowing a user to manually push and move the jack (101) around. Like in the preceding embodiment, the lever assembly (104) comprises an elongated portion (104a), an upper end (104b), a lower end (104c) and a handle (104d). Again as can be seen, the lower end (104c) of the lever assembly (104) is connected in an articulated manner to the main body (102), said connection being articulated with respect to a transverse axis of rotation (108). The lever assembly (104) is capable of being lowered with respect to said transverse axis of rotation (108) and arranged against the main body (102). The main body (102) of the jack (101) of the present embodiment further comprises a front rolling element (106), in this case in the form of a roller, and two rear rolling elements (107). The rear rolling elements (107) are located at a rear end (110) of the jack (1) and are in the form of two parallel planar side wheels in the present embodiment.

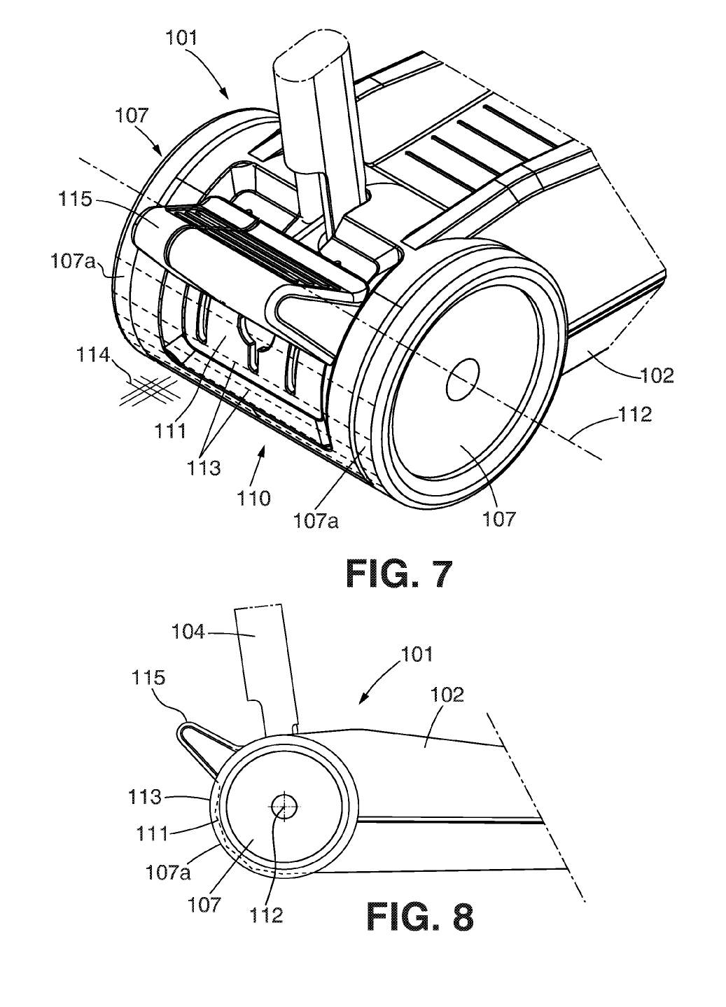

FIG. 7 shows a partial rear perspective view of the jack (101) of the preceding figure. As can be seen, the rear end (110) of the main body (102) is finished in a rear outer surface (111), said rear outer surface (111) being formed by more or less complex outer surfaces of the mechanisms and parts located at the rear end (110) of the main body (102). For the purposes of the present invention, the rear rolling elements (107) must be understood as not belonging to the rear outer surface (111). Particularly in the depicted embodiment, the rear rolling elements (107) are two parallel wheels arranged outside the rear outer surface (111), on both sides thereof. The rear rolling elements (107) are capable of rotating with respect to the main body (102) about an axis of rotation (112). Said rear rolling elements (107) have respective contact regions (107a) capable of being supported on a surface (114), allowing the rear rolling elements (107) to roll over said surface (114). In the depicted embodiment, said contact regions (107a) are the circumferential contours of each wheel. As shown in the drawing, the contact regions (107a), in the rotation thereof about the axis of rotation (112), demarcate an imaginary cylindrical outer surface of revolution (113) with respect to the axis of rotation (112), said outer surface of revolution (113) having been schematically depicted with discontinuous lines. According to the invention, the rear outer surface (111) is confined within said outer surface of revolution (113). Said confinement can be seen in the drawing by the fact that any portion of the rear outer surface (111) is located within the imaginary cylinder forming the outer surface of revolution (113). FIG. 8 shows a partial side view of the jack (101) of the preceding drawing in which it can be seen from the profile that the rear outer surface (111) schematically depicted with hidden (discontinuous) lines is confined within said outer surface of revolution (113) defined by contact regions (107a) of the rear rolling elements (107). The term ‘within’ is understood as the rear outer surface (111) being located closer to the axis of rotation (112) than the outer surface of revolution (113).

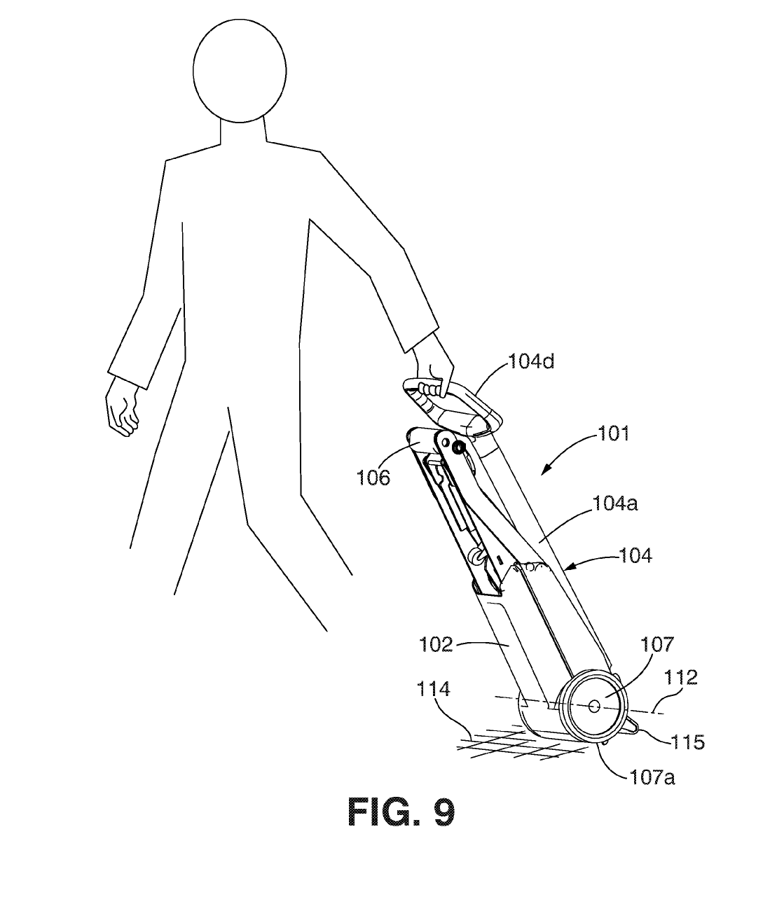

According to this embodiment, as shown in FIG. 9 the main body (102) is capable of being lowered with respect to the rear rolling elements (107) and the axis of rotation (112) to allow the jack (101) to acquire an inclined final position with respect to the surface (114), while maintaining contact between the contact regions (107a) of the rear rolling elements (107) and the surface (114), rolling of rear rolling elements (107) being allowed. The present embodiment therefore allows a user to transport or store the jack (101) by performing the following steps: folding the lever assembly (104) against the main body (102); gripping the handle (104d) of the lever assembly (104); pulling the handle (104d) upwards so that the main body (102) rotates with respect to the rear rolling elements (107) and is lifted off the ground or surface (114); then pulling the lifted jack (101) and dragging it comfortably as shown in the drawing.

Though not depicted in FIGS. 5 to 9, the present embodiment will preferably comprise a securing element for keeping the lever assembly (104) lowered against the main body (102), facilitating the entire operation of lifting and dragging the jack (101).

As shown in FIGS. 5 to 9, the jack (1) preferably comprises at least one protuberance (115) projecting radially from the outer surface of revolution (113) of the rear rolling elements (107). Said protuberance (115) serves as a support point against the ground or surface (114) to allow the jack (101) to remain upright once it has been lifted to a sufficiently inclined position (slightly more inclined than the position depicted in FIG. 9) in which the protuberance (115) contacts the surface (114). In the depicted embodiment, said protuberance (115) is a pedal which also serves for operating controlled unloading or for operating other mechanisms of the jack (101).

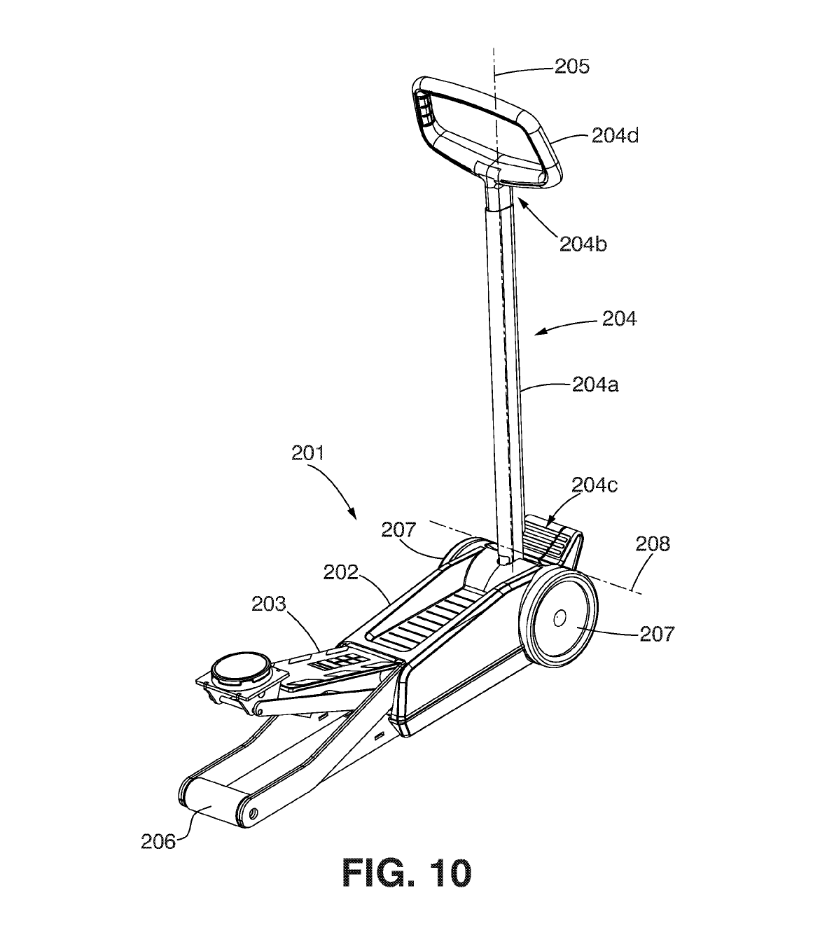

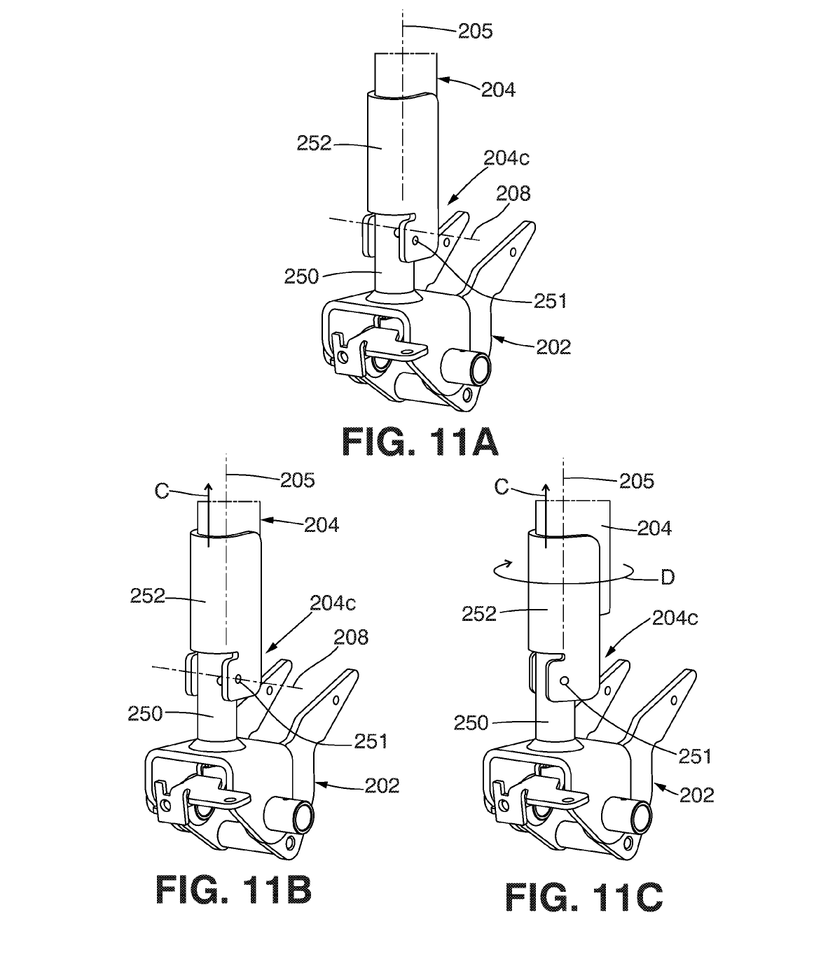

FIG. 10 shows an additional embodiment of a jack (201) according to the invention provided with a main body (202); a lifting element (203); a lever assembly (204) with an elongated portion (204a), an upper end (204b), a lower end (204c) and a handle (204d); a longitudinal axis (205); a front rolling element (206); two rear rolling elements (207); and a transverse axis of rotation (208) with respect to which the lever assembly (204) can be lowered. The particularity of this embodiment is illustrated in FIG. 11A, showing an enlarged perspective view of the lower end (204c) of the lever assembly (204) and the relationship of said lower end (204c) with some components of the main body (202), the complete main body (202) not being shown. Among the components of the main body (202) that are shown, it must be pointed out that the main body (202) comprises a portion (250) to which the lower end (204c) of the lever assembly (204) is connected. In the depicted embodiment, said portion (250) is integral with the rest of the main body (202), i.e., it does not have any relative movement with respect to the rest of the main body (202). The lower end (204c) of the lever assembly (204) is connected in an articulated manner to said portion (250). The connection is articulated with respect to a transverse axis of rotation (208), where the term “transverse” is understood as being perpendicular or substantially perpendicular to the longitudinal axis (205) of the lever assembly (204), and preferably parallel to the ground or surface on which the jack (201) is supported, and therefore parallel to the axles of the rolling elements (206, 207) or wheels provided on the jack (201).

The transverse axis of rotation (208) will optionally be provided by at least one rod (251) transversely inserted into the portion (250). The term “transversely” is understood as the rod being inserted in the direction of the transverse axis of rotation (208), i.e., in a direction perpendicular or substantially perpendicular to the longitudinal axis (205) of the lever assembly (204). As seen in the subsequent drawings showing this embodiment in a cross-section view, a single rod (251) going through the entire portion (250) transversely is preferably provided.

The lever assembly (204) of the present embodiment has several different use sequences or operating modes with which the lever assembly (204) performs different functions.

FIGS. 11A, 11B and 11C show a first use sequence of the jack (201) in general and of the lever assembly (204) in particular. First, FIG. 11A shows the lever assembly (204) in a position in which it is not capable of rotating with respect to the transverse axis of rotation (208), nor with respect to the longitudinal axis (205). In this position, the lever assembly (204) can be prepared to be used, for example, for lifting the lifting element (203), and therefore the heavy object or load, or for the user to push and move the jack (201) around. FIG. 11B shows the lever assembly (204) in a second longitudinal position with respect to the main body (202) acquired after the user has pulled the handle (204d) of the lever assembly (204) in the direction indicated by the arrow (C) hard enough to cause longitudinal movement of the lever assembly (204) with respect to the portion (250) of the main body (202) until reaching this second position. In this second position, the lever assembly (204) can rotate with respect to the longitudinal axis (205), i.e., rotate in the direction indicated by the arrow (D) as shown in FIG. 11C, in which the lever assembly (204) is shown slightly rotated in the clockwise direction. Said rotation preferably serves for operating lower mechanisms located in the inner area of the portion (250), below it and/or in any applicable area of the rest of the main body (202), which in turn allow causing the downward movement of the lifting element (203), these mechanisms not being relevant for the present invention in any case. Therefore, if the user applies force in the direction of the arrow (D) of FIG. 11C while at the same time continues to apply the upward longitudinal force as indicated by the arrow (C) (given that in the depicted embodiment the lever assembly (204) tends to return to the position of FIG. 11A due to gravitational force) while the lever assembly (204) is in the second position depicted in FIG. 11B, it may cause rotation of the lever assembly (204) and subsequent lowering of the lifting element (203) and the load supported thereon.

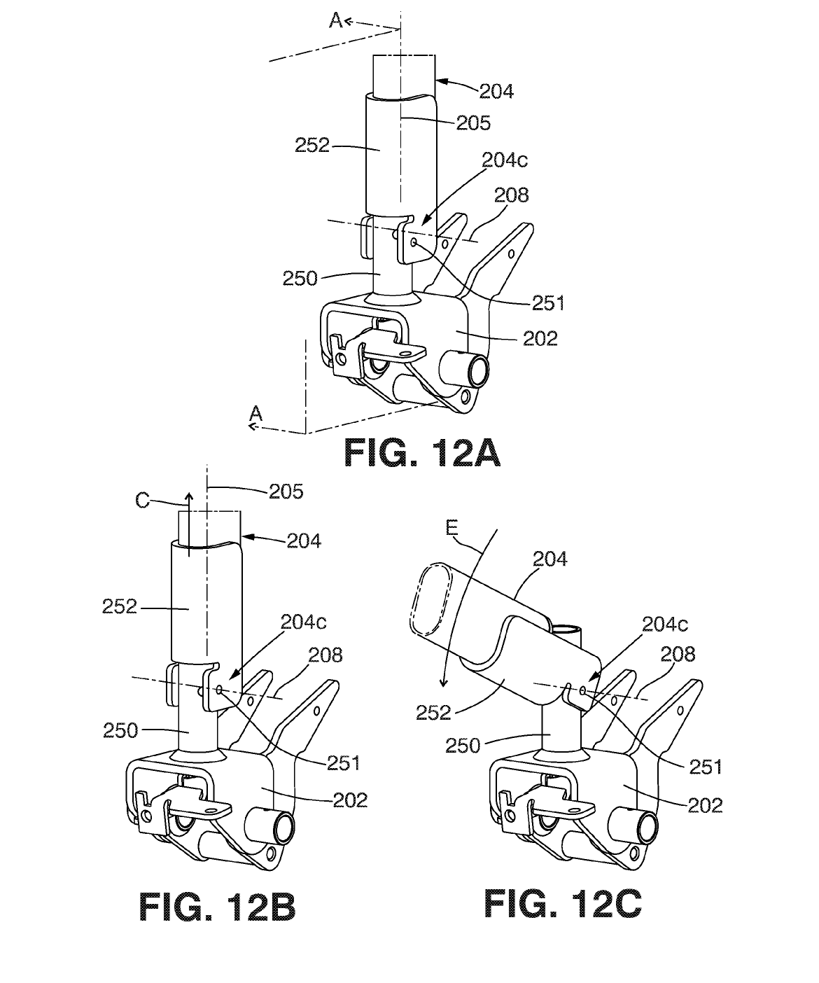

FIGS. 12A, 12B and 12C show a second use sequence of the jack (201) in general and of the lever assembly (204) in particular. FIG. 12A shows the lever assembly (204) in a first position identical to that of FIG. 11A, i.e., in a position in which it is not capable of rotating with respect to the transverse axis of rotation (208) nor with respect to the longitudinal axis (205). FIG. 12B shows the lever assembly (204) in a second longitudinal position identical to that of FIG. 11B acquired after the user has pulled the handle (204d) of the lever assembly (204) in the direction indicated by the arrow (C) hard enough to cause longitudinal movement of the lever assembly (204) with respect to the portion (250) of the main body (202) until reaching this second position. In this second position, the lever assembly (204) can be lowered with respect to the transverse axis of rotation (208) and the portion (250). FIG. 12C shows the lever assembly (204) being rotated with respect to the transverse axis of rotation (208) and the portion (250), as indicated with the arrow (E). This allows folding the lever assembly (204) against the main body (202) and reducing the total space occupied by the jack (201), facilitating storage thereof.

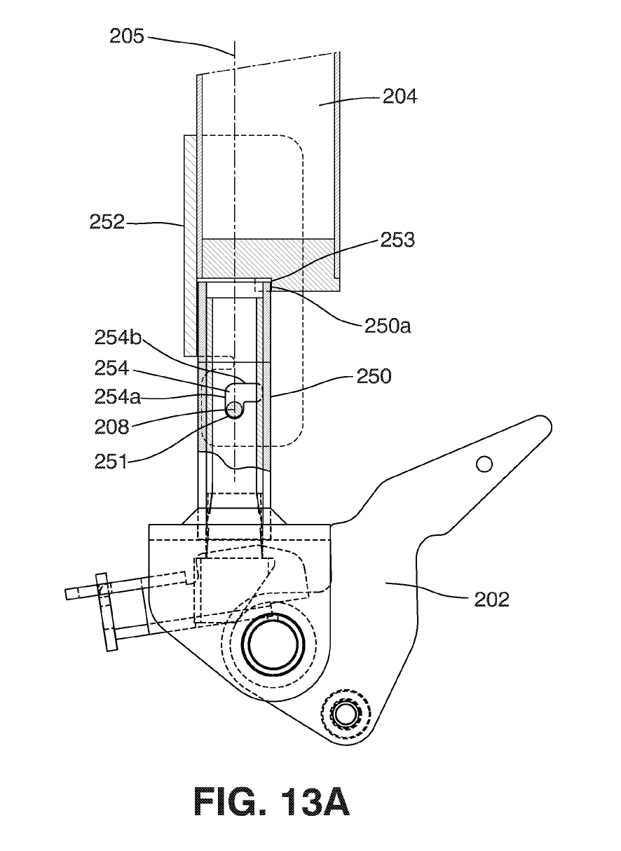

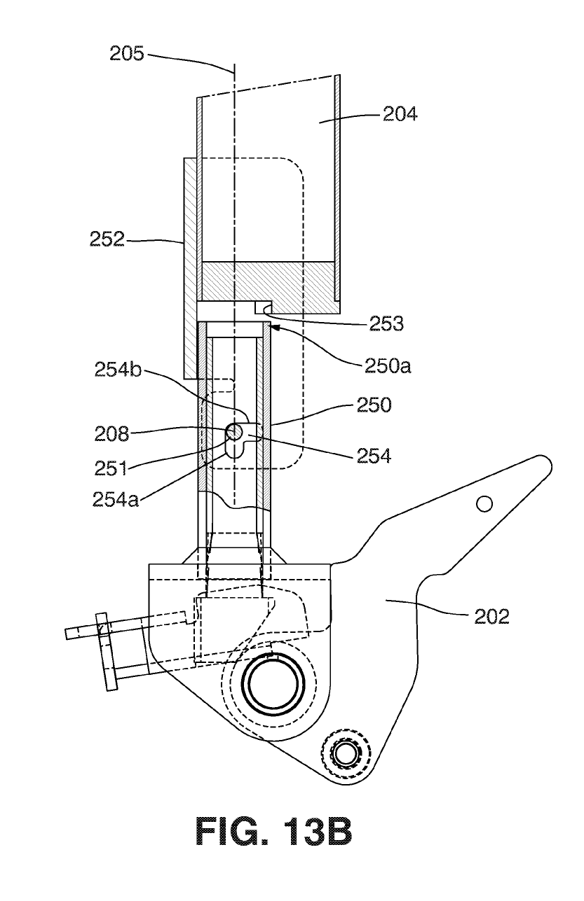

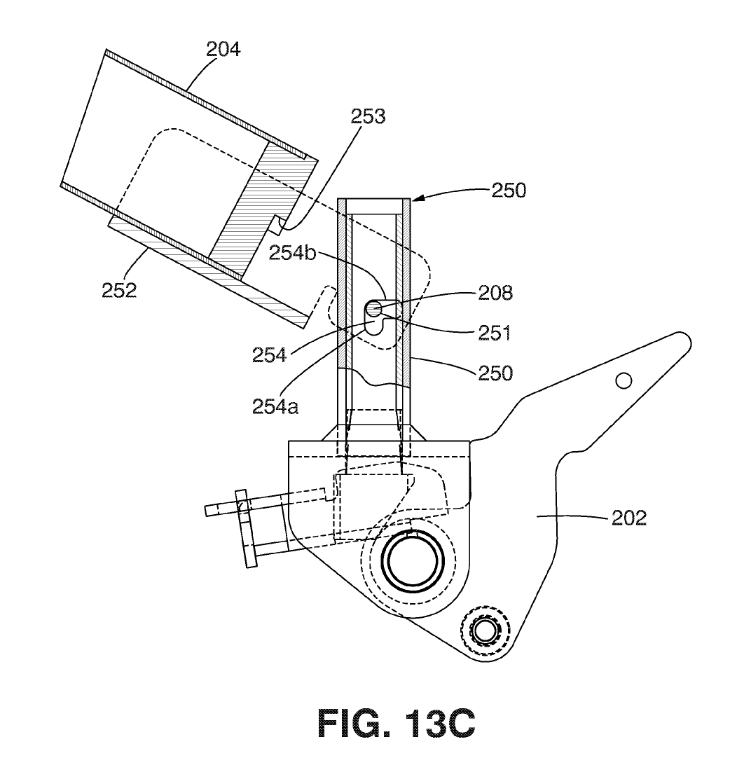

FIGS. 13A, 13B and 13C show three respective side views in partial cross-section of the assemblies of FIGS. 12A, 12B and 12C, the three sections being according to section plane A-A illustrated in FIG. 12A. As can be seen in FIGS. 13A, 13B and 13C, the lever assembly (204) preferably comprises in its lower area a stop surface (253) the relative position of which with respect to an upper end (250a) of the portion (250) changes when the lever assembly (204) is longitudinally moved with respect to the portion (250). In the situation of FIG. 13A, the stop surface (253) is in a lower position in which it contacts the upper end (250a) of the portion (250) of the main body (202) and prevents rotation of the lever assembly (204) with respect to a transverse axis of rotation (208), the longitudinal axis of the rod (251), in the event that the user tries to lower the lever assembly (204) against the main body (202). In contrast, in the situation of FIG. 13B the lever assembly (204) has been longitudinally lifted high enough so that the stop surface (203) is lifted above the upper end (250a) of the portion (250) of the main body (202). In this situation, the lever assembly (204) can be lowered with respect to the transverse axis of rotation (208) coinciding with the longitudinal axis of the rod (251), and therefore the lever assembly (204) can be lowered towards the main body (2) as shown in FIG. 13C because the stop surface (203) will not hit the portion (250) during lowering.

Preferably, as can seen by the fact that FIGS. 11B and 12B coincide, the position in which the lever assembly (204) can be lowered with respect to the transverse axis of rotation (208) and the position in which the lever assembly (204) can rotate with respect to the longitudinal axis (205) are the same position. In other words, rotation of the lever assembly (204) both with respect to the longitudinal axis (205) and with respect to the transverse axis of rotation (208) can occur in one and the same longitudinal position of the lever assembly (204) with respect to the portion (250) of the main body (202). This makes use of the jack more intuitive since the user will only have to bear in mind that one of the longitudinal positions of the lever assembly (204) serves to enable moving the jack or lifting the load, whereas the other position serves both for lowering the load and for lowering the lever assembly (204) against the main body (202) when the jack is to be stored.

FIGS. 13A, 13B and 13C also show that the portion (250) comprises two inverted L-shaped channels (254) arranged symmetrically on respective opposing sides of the portion (250), only one of them being shown in the drawings, specifically the one located farthest away from the observer. Both channels (254) comprise a longitudinal segment (254a) and a transverse segment (254b). The rod (251) is confined within the channels (254) and is capable of passing through same. As shown in FIG. 13A, when the rod (251) is located in the longitudinal segment (254a), the jack (201) is in the position in which the lever assembly (204) is not capable of rotating with respect to the transverse axis of rotation (208) provided by the longitudinal axis of the rod (251) due to the contact between the stop surface (253) and the upper end (250a) of the portion (250). The lever assembly (204) is not capable of rotating with respect to the longitudinal axis (205) either, in this case due to the rod (251) being transversely confined within the longitudinal segment (254a), i.e., due to the fact that it is only capable of being moved longitudinally within said segment. In contrast, as shown in FIG. 13B when the rod (251) is located in the transverse segment (254b), the jack (201) is in the position in which the lever assembly (204) can be lowered with respect to the transverse axis of rotation (208) provided by the longitudinal axis of the rod (251), given that maximum overlapping of the stop surface (253) with the portion (250) is less than or equal to movement of the rod (251) until reaching the transverse segment (254b), and therefore the stop surface (253) has exceeded the upper end (250a), the lever assembly (204) being free for lowering as illustrated in FIG. 13C. In the position of FIG. 13B, the lever assembly (204) can also rotate with respect to the longitudinal axis (205) since the rod is in a transverse segment allowing the rod (251) to follow a rotational path about the longitudinal axis (205) and passing through the transverse segment (254b) of the channels (254).

This embodiment of the jack (201) therefore comprises a lever assembly (204) which can have four different uses. The first use is to serve as a gripping and pushing element so that a user can push the jack (201) and move it around on the ground; this first use can be for when the lever assembly (204) is arranged in a position in which it does not move with respect to the portion (250) comprised in the main body (202), i.e., position depicted in FIG. 11A. The second use is to allow operation and subsequent upward movement of the lifting element (203) of the jack (by means of a hydraulic pump comprised in the jack, for example); FIG. 11A shows the lever assembly (204) prepared for this second use. The third use is to allow unloading or lowering of the lifting element of the jack, for which the lever assembly (204) must be arranged in a position in which it can rotate with respect to the longitudinal axis (205) and the portion (250) of the main body (202); said use is depicted in FIG. 11C. The fourth use of the lever assembly (204) is to allow it to be lowered against the main body (204) to reduce the space occupied by the jack (201) and facilitate storage of the jack (201), also assuring that the lever assembly (204) is always stored together with the jack (201) and that there is no risk of it getting lost; to that end, the lever assembly (204) must be arranged in the position of FIG. 12B and lowered as shown in FIG. 12C.

In the embodiment depicted in the drawings, the portion (250) is in the form of a tube portion projecting out of the main body (202), specifically in the rear area of said main body (202). The fact that the portion (250) to which the lever assembly (204) is connected is a tube-shaped portion facilitates designing the articulated connection therebetween, given that providing the lever assembly (204) with an outer connector (252) clamped onto the tube-shaped portion (250) and to which the rod (251) is fixedly or rotatably connected is sufficient.

1. Trolley jack (1; 101; 201) comprising a main body (2; 102; 202) with respect to which a lifting element (3; 103; 303) is capable of moving up or down for lifting a heavy object, and a lever assembly (4; 104; 204) capable of projecting upwards from the main body (2; 102; 202) along a longitudinal axis (5; 105; 205) for allowing a user to manually push and move the jack (1; 101; 201), characterized in that:
a lower end (4c; 104c; 204c) of the lever assembly (4; 104; 204) is connected in an articulated manner to the main body (2; 102; 202), said connection being articulated with respect to a transverse axis of rotation (8; 108; 208), the lever assembly (4; 104; 204) being capable of being lowered with respect to said transverse axis of rotation (8; 108; 208) and arranged against the main body (2; 102; 202).

2. Jack (1; 101; 201) according to claim 1, characterized in that the lever assembly (4; 104; 204) is telescopic and its length is variable.

3. Jack (1) according to claim 1, characterized in that it comprises at least one securing element (9) for fixing the position of the lever assembly (4) when it is lowered with respect to the transverse axis of rotation (8) and arranged against the main body (2).

4. Jack (101) according to claim 1, characterized in that the main body (102) comprises a rear end (110) in which at least two rear rolling elements (107) are arranged, where the rear end (110) is finished in a rear outer surface (111), said rear rolling elements (107) being capable of rotating with respect to the main body (2) about an axis of rotation (112) and said rear rolling elements (107) having respective contact regions (107a) capable of being supported on a surface (114) such that the rear rolling elements (107) allow the jack (101) to roll over said surface (114), characterized in that the contact regions (107a) demarcate a cylindrical outer surface of revolution (113) with respect to the axis of rotation (112), and in that the rear outer surface (111) is confined within said outer surface of revolution (22), where the main body (102) is capable of being lowered with respect to the rear rolling elements (107) and the axis of rotation (112) between a horizontal initial position and an inclined final position while maintaining contact between contact regions (107a) of the rear rolling elements (107) and the surface (114).

5. Jack (101) according to claim 4, characterized in that it comprises at least one protuberance (115) projecting radially from the outer surface of revolution (113) of the rear rolling elements (107).

6. Jack (201) according to claim 1, characterized in that the lower end (204c) of the lever assembly (204) is connected in an articulated manner to a portion (250) comprised in the main body (202), and in that the lever assembly (204) is capable of adopting several longitudinal positions with respect to said portion (250): one position in which the lever assembly (204) is not capable of rotating with respect to the transverse axis of rotation (208) nor with respect to the longitudinal axis (205); one position in which the lever assembly (204) can rotate with respect to the longitudinal axis (205); and one position in which the lever assembly (204) can be lowered with respect to the transverse axis of rotation (208), for folding the lever assembly (204) against the main body (202) and reducing the total space occupied by the jack (201).

7. Jack (201) according to claim 6, characterized in that the transverse axis of rotation (208) is provided by at least one rod (251) transversely inserted into the portion (250).

8. Jack (201) according to claim 7, characterized in that it comprises a single rod (251) going through the portion (250) transversely.

9. Jack (201) according to claim 6, characterized in that the portion (250) is a tube portion projecting out of the main body (202).

10. Jack (201) according to claim 6, characterized in that the position in which the lever assembly (204) can be lowered with respect to the transverse axis of rotation (208) and the position in which the lever assembly (204) can rotate with respect to the longitudinal axis (205) are the same position.

11. Jack (201) according to claim 10, characterized in that the lever assembly (204) comprises in its lower area a stop surface (253) which contacts the portion (250) when the lever assembly (204) is in the position in which it is not capable of rotating with respect to the transverse axis of rotation (208) nor with respect to the longitudinal axis (205), preventing rotation of the lever assembly (204) with respect to the transverse axis of rotation (208).

12. Jack (201) according to claim 10, characterized in that the portion (250) comprises two inverted L-shaped channels (254) arranged symmetrically on respective opposing sides of the portion (250), both channels (254) comprising a longitudinal segment (254a) and a transverse segment (254b), a rod (251) passing through the channels (254), such that when the rod (251) is located in the longitudinal segment (254a), the jack (201) is in the position in which the lever assembly (204) is not capable of rotating with respect to the transverse axis of rotation (208) nor with respect to the longitudinal axis (205), whereas when the rod (251) is located in the transverse segment (254b), the jack (201) is in the position in which the lever assembly (204) can be lowered with respect to the transverse axis of rotation (208) and can also rotate with respect to the longitudinal axis (205).
